(19) United States
(12) Patent Application Publication
(10) Pub. No.: US 2021/0240956 A1
(43) Pub. Date: Aug. 5, 2021

(54) SYSTEMS AND METHODS FOR ENCODING EXECUTABLE CODE IN BARCODES

(71) Applicant: LabWare Holdings, Inc., Wilmington, DE (US)

(72) Inventor: Vance V. Kershner, Wilmington, DE (US)

(73) Assignee: LabWare Holdings, Inc., Wilmington, DE (US)

(21) Appl. No.: 16/782,237

(22) Filed: Feb. 5, 2020

(51) Int. Cl. G06K 7/14; H04L 9/32; H04L 29/06; G06K 19/06

(52) U.S. Cl. CPC G06K 7/1434; G06K 19/06037; H04L 63/0428; H04L 9/3247

(57) ABSTRACT

A system for encoding executable code into barcodes is provided. Executable code corresponding to a particular behavior, feature, or testing process of an application is encoded into a barcode such as a quick response (“QR”) code. The barcode may be placed at a location where the particular behavior, feature, or testing process may be useful or desired. Later, when a user is at the location, they may use their device to read the barcode and extract the executable code directly from the barcode. The device and/or application may then execute the executable code thereby incorporating the associated behavior, feature, or testing process into the application.

### BACKGROUND

When a device such as a computer or smartphone desires to run an application, the device may either run executable code corresponding to the application that is stored on the device or may download and run executable code corresponding to the application from a server. Often an application may use a combination of locally stored code and code remotely retrieved from a server. Storing some or all of the executable code for an application may be desirable in that portions of the executable code corresponding to particular application behaviors or features can be provided to a device as needed, resulting in lower storage requirements for the application.

However, there are drawbacks associated with downloading executable code from a server. In particular, downloading executable code requires a networking connection between the device and the server. For devices that are used at locations where networking connections are unreliable or unavailable, downloading executable code for certain applications may not feasible. This may force users to proactively download executable code for application behaviors and features that they may or may not need, which may lead to excessive and unnecessary storage requirements for the application.

### SUMMARY

A system for encoding executable code into barcodes is provided. Executable code corresponding to a particular behavior, feature, or testing process of an application is encoded into a barcode such as a quick response (“QR”) code. The barcode is placed at a location where the particular behavior, feature, sampling process, or testing process may be useful or desired. Later, when a user is at the location, they may use their device to read the barcode and extract the executable code directly from the barcode. The device and/or application may then execute the executable code thereby incorporating the associated behavior, feature, or testing process into the application. Alternatively, or additionally, the barcode may be read from a previously captured image, or from an electronic communication such as an email or an SMS message.

As may be appreciated, the use of barcodes to distribute executable code provides many advantages over the prior art. First, because the executable code is extracted by the device and/or application directly from the barcode, no server or networking connection is needed to enable the particular behavior, feature, sampling process, or testing process associated with the executable code. This may be particularly advantageous in remote locations where networking connections are unavailable or unreliable, and avoids the costs associated with maintaining a server or networking infrastructure for purposes of code distribution.

In an embodiment, a method for extracting and executing code from a barcode is provided. The method includes: receiving a barcode by a computing device, wherein executable code is encoded into the barcode; decoding the barcode to extract the executable code by the computing device; and executing the extracted executable code by the computing device.

Embodiments may include some or all of the following features. The executable code may include LIMS Basic code, JavaScript code, or Smalltalk code. The executable code may be associated with a sampling process or a testing process. The barcode may be located at a location associated with the sampling process or the testing process. Decoding the barcode to extract the executable code may include extracting the executable code without using a networking connection associated with the computing device. Receiving the barcode may include receiving an image of the barcode and retrieving the barcode from the image. The barcode may include a matrix barcode. The barcode may include a quick response barcode. Executing the extracted executable code by the computing device may include decrypting the extracted executable code. The method may further include decoding the barcode to extract a digital signature; authenticating the extracted executable code using the digital signature; and executing the extracted executable code in response to the authentication.

In an embodiment, a method for encoding executable code into a barcode is provided. The method includes: receiving executable code by a computing device, wherein the executable code defines a testing process, or a sampling process associated with a location; encoding the executable code into a barcode by the computing device; and placing the barcode at the location.

Implementations may include some or all of the following features. The method may further include: generating a digital signature; and encoding the digital signature into the barcode. The method may further include: encrypting the executable code; and encoding the encrypted executable code into the barcode. The barcode may include a matrix barcode. The method may further include sending an electronic communication that includes the barcode.

In an embodiment, a system is provided. The system may include: at least one processor; and a non-transitory computer readable medium. The computer readable medium may include instructions that, when executed by the at least one processor, cause the system to: receive a barcode, wherein executable code is encoded into the barcode; decode the barcode to extract the executable code; and execute the extracted executable code.

Embodiments may include some or all of the following features. The executable code may include LIMS Basic code, JavaScript code, or Smalltalk code. The executable code may be associated with a testing process or a sampling process. Decoding the barcode to extract the executable code may include extracting the executable code without using a networking connection associated with the system. The barcode may include a quick response barcode.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is an illustration of an example barcode;

FIG. 2 is an illustration of an example barcode system;

FIG. 3 is an illustration of an example mobile system;

FIG. 4 is an illustration of a mobile system capturing an image of a barcode;

FIG. 5 is an illustration of a mobile system executing code extracted from an image of a barcode;

FIG. 6 is an illustration of an example method for encoding executable code into a barcode;

FIG. 7 is an illustration of an example method for extracting executable code from a barcode; and

FIG. 8 illustrates an example computing device.

### DETAILED DESCRIPTION

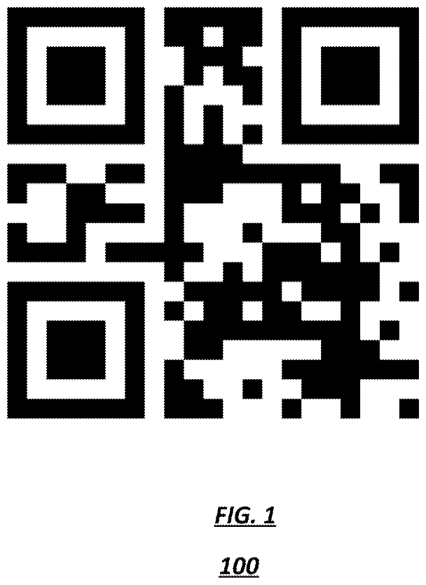

FIG. 1 is an illustration of an example barcode 100. In the example shown, the barcode 100 is a QR code; however, other types of barcodes may be used such as Code 38, Code 39, Interleaved 2 of 5, PDF 417, and matrix barcodes.

Generally, the barcode 100 may encode data in the matrix or pattern formed by the alternating dark and light areas of the barcode. When a smartphone or other mobile computing device such as a laptop captures an image of the barcode, software on the mobile computing device decodes the barcode 100 and extracts the data.

Typically, barcodes 100 are used to encode instructions that invoke existing executable code or applications that are stored on mobile computing devices. For example, a company such as ACME may place a barcode 100 on an advertisement. The company may encode the URL “www.acme.com” into the barcode 100. When a user captures an image of the barcode 100 using their mobile computing device, the mobile computing device may extract the URL and cause a web browsing application to open the URL. In the example, only the URL was encoded into the barcode 100, and the retrieval and display of the URL relied on the existence of executable code corresponding to the web browsing application stored on the mobile computing device as well as the networking connection between the mobile device and the ACME server.

As another example, a company may produce collectable cards directed towards children. Each card may include an image and description of a character. In addition, the company may place a barcode 100 on each card that includes an identifier of the associated character. The company may further provide an application associated with the collectable cards that may be downloaded to a mobile computing device. When a user captures an image of the barcode 100 using their mobile computing device, the application may extract the identifier of the character from the barcode and may cause a stored video of the character to be played to the user on their mobile computing device. Similar to the previous example, all of the processing related to the retrieval and displaying of the stored video is performed using executable code previously downloaded and stored on the mobile computing device.

As may be appreciated, both examples described above rely on the presence of existing executable code stored on the mobile computing device or on a connected server. Furthermore, the first example additionally requires the availability of a networking connection between the mobile computing device and a server. Thus, in the described examples the barcodes 100 would be useless for users that have not downloaded the requisite applications or who found themselves in an environment where no networking connection was available with a server.

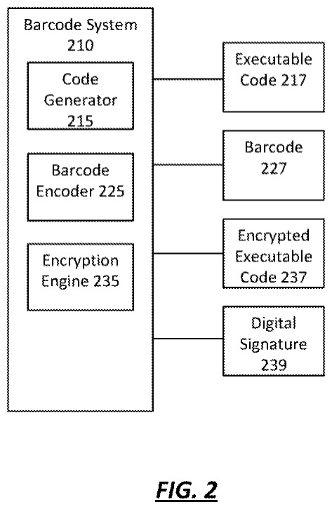

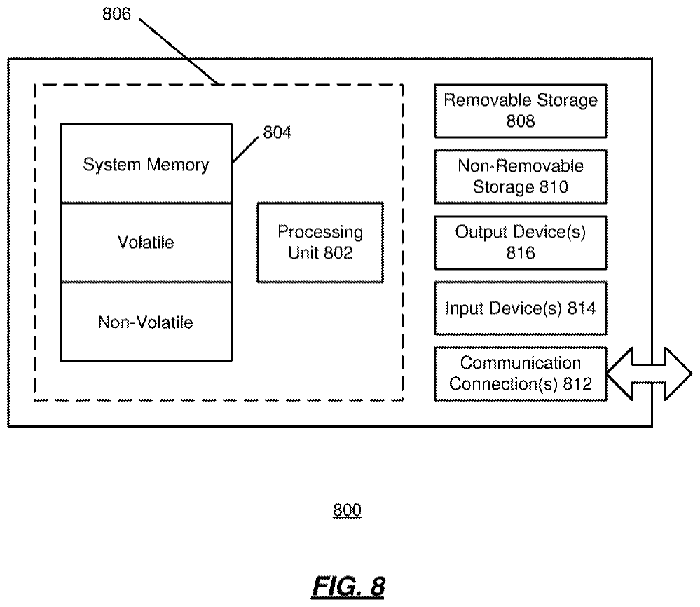

FIG. 2 is an illustration of an example barcode system 210 for encoding executable code 217 into a barcode 227. As shown, the barcode system 210 includes various modules and components such as a code generator 215, a barcode encoder 225, and an encryption engine 235. More or fewer engines, modules, or components may be supported by the barcode system 210. Depending on the embodiment, each of the code generator 215, barcode encoder 225, and encryption engine 235 may be implemented together or separately by one or more general purpose computing devices such as the computing system 800 illustrated with respect to FIG. 8.

The code generator 215 may generate executable code 217. The executable code 217 may be code that can be executed by a mobile computing device such as a smartphone, laptop, videogame console, or tablet. The executable code 217 may provide a new feature, behavior, sampling process, or testing process to an application of the mobile computing device. For example, the application may be a laboratory management application, and the executable code 217 may be for a new testing process for a particular type of sample. In another example, the application may be a spreadsheet application, and the executable code 217 may be for a new function that may be applied to a dataset. Alternatively or additionally, the executable code 217 may be for a complete application that may be executed by the mobile computing device without reference to any existing applications on the mobile computing device. In some embodiments, the executable code 217 may be LIMS Basic code. Other types of code may be supported such as JavaScript, BASIC, Smalltalk, etc. Any known or unknown programing language may be used.

The executable code 217 may be associated with a particular location at which the executable code 217 is likely to be executed. Suitable locations include laboratories, sites, and even particular types of machinery or equipment.

The barcode encoder 225 may generate a barcode 227 from the executable code 217. Depending on the embodiment, the barcode 227 may be a 2-D barcode such as a QR code or a matrix code. Other types of barcodes 227 may be supported. Any method for generating a barcode 227 by encoding text may be used.

Depending on the embodiment, rather than generate the barcode 227 from the executable code 217, the encryption engine 235 may first encrypt the executable code 217 to create encrypted executable code 237. The barcode encoder 225 may then generate the barcode 227 from the encrypted executable code 237. The encryption engine 235 may encrypt the executable code 217 using a private key associated with the barcode system 210. The private key may be a secret key that is known only to the barcode system 210. There may be a corresponding public key that is distributed to the mobile computing devices. The mobile computing devices may use the public key to decrypt the encrypted executable code 237, thereby authenticating the executable code 217 as coming from the barcode system 210. Other methods of encryption and/or authentication may be used.

Further, rather than encrypting the executable code 217, the encryption engine 235 may generate a digital signature 239 using a portion of the executable code 217 and the private key of the barcode system 210. The digital signature 239 may be encoded into the barcode 227 along with the executable code 217 and may be used by the mobile computing device to authenticate the executable code 217.

The generated barcode 227 may be placed at the location associated with the executable code 217. For example, if the executable code 217 is for a testing process that is to be used at a location to collect a particular sample, the barcode 227 may be printed onto a sign, sticker, card, or notice that is displayed at the location. In another example, if the executable code 217 is to control or interface with a particular piece of equipment at a laboratory, the barcode 227 may be printed onto a sticker and affixed to the equipment. The barcode 227 may be placed and displayed in such a way as to be easily noticed by a user associated with a mobile computing device as well as easily received by, or scanned by, the mobile computing device.

In other embodiments, the barcode 227 may be emailed or otherwise provided electronically to a user. The user may then import, scan, or receive the barcode 227 from the email or other type of electronic communication.

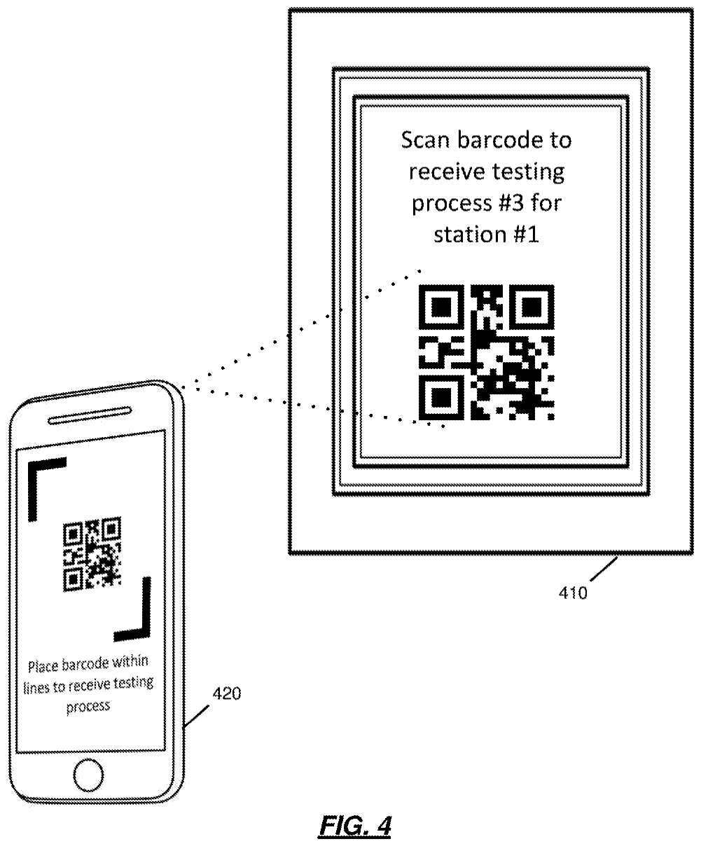

For example, with reference to FIG. 4 is shown an example sign 410 that includes a barcode 217. The sign 410 includes the text “Scan barcode to receive testing process #3 for station #1” that indicates to the user that the barcode 217 includes executable code correspond to the testing process #3 that is meant to be used at a location corresponding to the station #1. The sign 410 may be hung at or around the location corresponding to the station #1. Example signs 410 include stickers, posters, and cards.

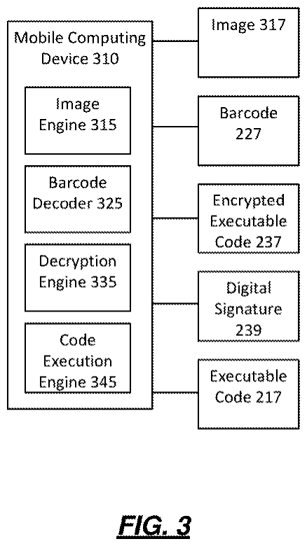

FIG. 3 is an illustration of an example mobile computing device 310 for decoding a barcode 227 to extract and execute executable code 217 encoded into the barcode 227 by the barcode system 210. As shown, the mobile computing device 310 includes various modules and components such as an image engine 315, a barcode decoder 325, a decryption engine 335, and a code execution engine 345. More or fewer engines, modules, or components may be supported by the barcode system 210. Depending on the embodiment, the mobile computing device may be implemented by one or more general purpose computing devices such as the computing system 800 illustrated with respect to FIG. 8.

The image engine 315 may receive an image 317 of a barcode 227. Depending on the embodiment, the image engine 315 may be part of the camera functionality commonly found on mobile computing devices 310, such as smartphones. Typically, a user associated with the mobile computing device 310 may see the barcode 227 at or around a particular location. The user may cause the image engine 315 to receive an image 317 that includes the barcode 227 by pointing their mobile computing device 310 towards the barcode 227. The image engine 315 may then receive the image 317 without the user having to take any actions such as opening a camera application associated with their mobile computing device 310. Note that when the image 317 is received by the image engine 315, the image engine 315 may or may not store the image 317.

For example, returning to FIG. 4, a user may be executing a laboratory management application on the mobile computing device 420. The user may see the barcode 227 on the sign 410 and may indicate to the laboratory management application that they would like to receive the executable code 217 associated with the barcode 227. In response, the laboratory management software has used the image engine 315 to put the mobile computing device 420 into a “scan mode” where the image engine 315 can receive an image 317 of the barcode 227. As can be seen on the screen of the mobile computing device 420, the user has lined up the barcode 227 of the sign 410 in a reticle to receive an image 317 of the barcode 227.

Returning to FIG. 3, after the image 317 is received, the barcode decoder 325 may process the image 317 to extract the executable code 217. Any system or method for decoding a barcode 227 may be used.

Depending on the embodiment, the barcode decoder 325 may extract encrypted executable code 237, and/or a digital signature 239 from the barcode 227. Where the barcode decoder 325 extracts an encrypted executable code 237, the decryption engine 335 may attempt to decrypt the encrypted executable code 237 using a public key of the barcode system 210. If the decryption engine 335 successfully decrypts the encrypted executable code 237 then the corresponding executable code 217 is authenticated as having been provided by the barcode system 210. Else, the executable code 217 is not authenticated. Depending on the embodiment, the code execution engine 345 may only execute executable code 217 that has been authenticated.

Where the barcode decoder 325 extracts a digital signature 239, the decryption engine 335 may attempt to authenticate the executable code 217 using a public key of the barcode system 210 and the digital signature 239. In particular, the decryption engine 335 may decrypt the digital signature 239 and may compare the decrypted digital signature 239 to a portion of the executable code 217. If they match, then the executable code 217 is authenticated. Else, the executable code 217 is not authenticated.

The code execution engine 345 may execute the executable code 217. Depending on the embodiment, the code execution engine 345 may execute the executable code 217 to provide a new behavior, feature, sampling process, or testing process to an application such as a laboratory management application executing on the mobile computing device 310.

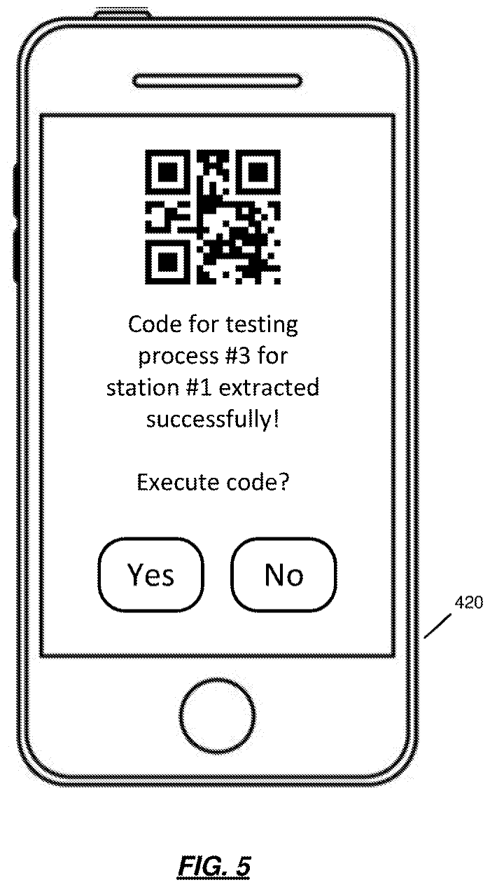

For example, continuing to FIG. 5 is illustrated the mobile computing device 420 of FIG. 4 after having successfully extracted the executable code 217 corresponding to the “testing process #3.” Accordingly, on the display of the mobile computing device 420 is an indication that the executable code 217 was successfully extracted and optionally authenticated. The display further includes user interface elements labeled “Yes” and “No” that the user of the mobile device 420 can use to either start the execution of the code corresponding to the “testing process #3” or skip the execution of the code.

As may be appreciated, the code execution engine 345 may provide the new feature, behavior, sampling process, or testing process using only the executable code 217 extracted from the barcode 227. Accordingly, the barcode 227 (and the executable code 217) does not include any references to other sources of executable code such as network sources or locations of the mobile computing device 310 from which additional executable code may be retrieved. As a result, the mobile computing device 310 can receive and execute the executable code 217 from the barcode 227 without having a networking connection available, without having access to an external server or data source, or without having previously downloaded or stored any additional executable code.

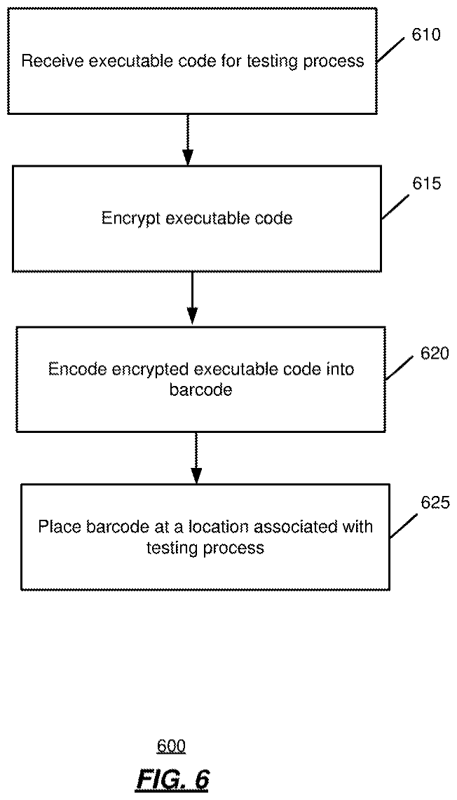

FIG. 6 is an illustration of an example method 600 for encoding executable code into a barcode. The method 600 may be implemented by the barcode system 210.

At 610, executable code for a testing process is received. The executable code 217 may be received by the barcode encoder 225 from the code generator 215. The executable code 217 may be LIMS basic code and may be sized based on the type of barcode 227 that is generated by the barcode encoder 225. Other types of code may be received. For example, if the barcode 227 is a QR code then the maximum size of the executable code 217 may be approximately 1,264 characters. Other types of known and unknown barcodes 227 may be supported.

At 615, the executable code is encrypted. The executable code 217 may be encrypted to generate encrypted executable code 237 by the encryption engine 235. Any type of encryption may be used. Alternatively, the executable code 217 may not be encrypted, or the encryption engine 235 may generate a digital signature 239 from the executable code 237.

At 620, the encrypted executable code is encoded into a barcode. The encrypted executable code 237 may be encoded into a barcode 227 by the barcode encoder 225. Alternatively, the unencrypted executable code 217 may be encoded into the barcode 227, or the executable code 217 and a digital signature 239 may be encoded into the barcode 227. Any method for encoding data into barcodes 227 may be used.

At 625, the barcode is placed at a location associated with the testing process. The barcode 227 may be placed by a user or administrator along with instructions on how to use the barcode 227 and an indicator of the particular testing process whose code is encoded into the barcode 227. Alternatively, or additionally, the barcode 227 may be placed on a card that is distributed to one or more users, or the barcode 227 may be electronically distributed to one or more users (e.g., email or SMS).

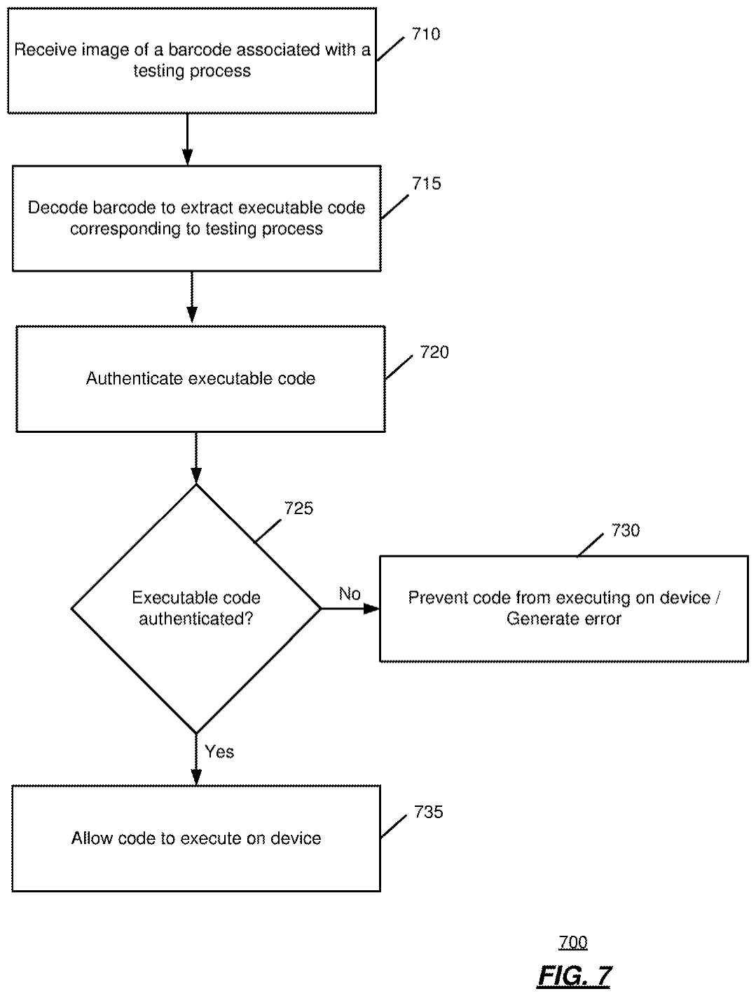

FIG. 7 is an illustration of an example method 700 for extracting executable code from a barcode. The method 700 may be implemented by the mobile computing device 310.

At 710, an image of a barcode associated with a testing process is received. The image 317 may be received by the barcode decoder 325 from the image engine 315. The image 317 may include the barcode 227 and may have been received by the image engine 315 at a location associated with the testing process. For example, the image 317 may be of a sign, sticker, or card placed at the location that includes the barcode 227 and an indication of the associated testing process. As another example, the image 317 may be received from an email or other electronic communication. Note that the method 700 is not limited to testing processes and may include sampling processes, behaviors, or features.

At 715, the barcode is decoded to extract executable code corresponding to the testing process. The barcode 227 may be decoded by the barcode decoder 325. Any method for decoding a barcode 227 may be used. Depending on the embodiment, the barcode decoder 325 may extract executable code 217, executable code 217 and a digital signature 239, or encrypted executable code 237.

At 725, the executable code is authenticated. The executable code 217 may be authenticated by the decryption engine 335. In embodiments where encrypted executable code 237 is extracted, the decryption engine 335 may authenticate the executable code 217 by decrypting the encrypted executable code 237 using a public key associated with the barcode system 210. In embodiments where the executable code 217 and a digital signature 239 are extracted, the decryption engine 335 may authenticate the executable code 217 by decrypting the digital signature 239 using the public key associated with the barcode system 210. In embodiments where only the executable code 217 is extracted, the decryption engine 335 may presume that the executable code 217 is authentic.

If the executable code 217 cannot be authenticated, then the method 700 may continue to 730. Else, the method 700 may continue at 735.

At 730, the executable code 217 is prevented from being executed. The executable code may be prevented from being executed by the code execution engine 345. Depending on the embodiment, the code execution engine 345 may display an error or warning to the user of the mobile computing device 310 indicating that the code cannot be authenticated and will not be executed.

At 735, the executable code 217 is executed. The executable code 217 may be executed by the code execution engine 345. By executing the executable code 217, the code execution engine 345 may cause the mobile computing device 310 to perform the testing process associated with the barcode 227.

FIG. 8 shows an exemplary computing environment in which example embodiments and aspects may be implemented. The computing system environment is only one example of a suitable computing environment and is not intended to suggest any limitation as to the scope of use or functionality.

Numerous other general purpose or special purpose computing system environments or configurations may be used. Examples of well-known computing systems, environments, and/or configurations that may be suitable for use include, but are not limited to, personal computers, servers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 8, an exemplary system for implementing aspects described herein includes a computing device, such as computing device 800. In its most basic configuration, computing device 800 typically includes at least one processing unit 802 and memory 804. Depending on the exact configuration and type of computing device, memory 804 may be volatile (such as random access memory (RAM)), non-volatile (such as read-only memory (ROM), flash memory, etc.), or some combination of the two. This most basic configuration is illustrated in FIG. 8 by dashed line 806.

Computing device 800 may have additional features/functionality. For example, computing device 800 may include additional storage (removable and/or non-removable) including, but not limited to, magnetic or optical disks or tape. Such additional storage is illustrated in FIG. 8 by removable storage 808 and non-removable storage 810.

Computing device 800 typically includes a variety of tangible computer readable media. Computer readable media can be any available tangible media that can be accessed by device 800 and includes both volatile and non-volatile media, removable and non-removable media.

Tangible computer storage media include volatile and non-volatile, and removable and non-removable media implemented in any method or technology for storage of information such as computer readable instructions, data structures, program modules or other data. Memory 804, removable storage 808, and non-removable storage 810 are all examples of computer storage media. Tangible computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 800. Any such computer storage media may be part of computing device 800.

Computing device 800 may contain communications connection(s) 812 that allow the device to communicate with other devices. Computing device 800 may also have input device(s) 814 such as a keyboard, mouse, pen, voice input device, touch input device, etc. Output device(s) 816 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for extracting and executing code from a barcode comprising:
receiving a barcode by a computing device, wherein executable code is encoded into the barcode;
decoding the barcode to extract the executable code by the computing device; and
executing the extracted executable code by the computing device.

2. The method of claim 1, wherein the executable code comprises LIMS Basic code, JavaScript code, or Smalltalk code.

3. The method of claim 1, wherein the executable code is associated with a sampling process or a testing process.

4. The method of claim 3, wherein the barcode is located at a location associated with the sampling process or the testing process.

5. The method of claim 1, wherein decoding the barcode to extract the executable code comprises extracting the executable code without using a networking connection associated with the computing device.

6. The method of claim 1, wherein receiving the barcode comprises receiving an image of the barcode and retrieving the barcode from the image.

7. The method of claim 1, wherein the barcode comprises a matrix barcode.

8. The method of claim 1, wherein the barcode comprises a quick response (“QR”) barcode.

9. The method of claim 1, wherein executing the extracted executable code by the computing device further comprises decrypting the extracted executable code.

10. The method of claim 1, further comprising:
decoding the barcode to extract a digital signature;
authenticating the extracted executable code using the digital signature; and
executing the extracted executable code in response to the authentication.

11. A method for encoding executable code into a barcode comprising:
receiving executable code by a computing device, wherein the executable code defines a testing process, or a sampling process associated with a location;
encoding the executable code into a barcode by the computing device; and
placing the barcode at the location.

12. The method of claim 11, further comprising:
generating a digital signature; and
encoding the digital signature into the barcode.

13. The method of claim 11, further comprising:
encrypting the executable code; and
encoding the encrypted executable code into the barcode.

14. The method of claim 11, wherein the barcode comprises a matrix barcode.

15. The method of claim 11, further comprising sending an electronic communication that includes the barcode.

16. A system comprising:
at least one processor; and
a non-transitory computer readable medium comprising instructions that, when executed by the at least one processor, cause the system to:
receive a barcode, wherein executable code is encoded into the barcode;
decode the barcode to extract the executable code; and
execute the extracted executable code.

17. The system of claim 16, wherein the executable code comprises LIMS Basic code, JavaScript code, or Smalltalk code.

18. The system of claim 16, wherein the executable code is associated with a testing process or a sampling process.

19. The system of claim 16, wherein decoding the barcode to extract the executable code comprises extracting the executable code without using a networking connection associated with the system.

20. The system of claim 16, wherein the barcode comprises a quick response (“QR”) barcode.
